(19) United States
(12) Patent Application Publication
(10) Pub. No.: US 2012/0005392 A1
(43) Pub. Date: Jan. 5, 2012

(54) INFORMATION PROCESSING SYSTEM

(75) Inventor: Nobuo Yagi, Hamamatsu (JP)

(73) Assignee: Hitachi, Ltd.

(21) Appl. No.: 13/145,065

(22) PCT Filed: Jan. 23, 2009
(86) PCT No.: PCT/JP2009/000260

§ 371 Date: Sep. 20, 2011

(51) Int. Cl. G06F 13/20

(52) U.S. Cl. 710/313

(57) ABSTRACT

It is desirable to flexibly provide a single information processing device with a system capable of connecting a large number of input-output devices, and an inexpensive system capable of sharing an input-output device by a plurality of servers. To achieve this, there is provided an information system including a server chassis and an IO chassis. The server chassis includes a plurality of server blades each having a processor, a memory, and a root complex, and a first multi-root PCIe switch connected to the individual server blades. The IO chassis includes a plurality of PCIe slots to which input-output devices are attached, and a second multi-root PCIe switch connected to the individual PCIe slots. The first multi-root PCIe switch and the second multi-root PCIe switch are connected together by a PCIe cable.

### TECHNICAL FIELD

The present invention relates to an information processing system. More particularly, the present invention relates to an information processing system capable of achieving aggregation, sharing, and expansion of IO by connecting a computer and a plurality of input-output (IC)) devices by using the PCIe (Peripheral Component Interconnect Express) standard.

### BACKGROUND ART

In a large-scale information processing system with a large number of IOs to be connected to one computer, in general, an expansion IO chassis is used for mounting such a large number of IOs. For example, in a computer system shown in FIG. 24, a server chassis 240 including memories 2401, CPUs 2402, a root complex 2403, and PCIe slots 2404, is connected to an expansion IO chassis 242 including a

PCIe switch 2421 and PCIe slots 2422. In this case, IO expansion is achieved by connecting a pass through card to the PCIe slot 2404 of the server chassis 240, and by connecting the pass through card with the expansion IO chassis 242 by a PCIe cable 244.

Further, in order to reduce the initial cost of the computer system, there is a demand for sharing one IO with a plurality of computers. For this purpose, one IO is shared among a plurality of server blades in the server chassis by using the multi-root PCIe technology. For example, although an IO has been exclusively owned by one computer up to now, sharing of an IO among a plurality of computers is achieved. At this time, each of the computers issues a transaction with a tag indicating the source computer of the particular transaction.

With respect to the information processing system using the PCIe technology, for example, Patent Document 1 discloses a method in which one host CPU set 310 is connected to PCIe end points 370 to 390 through a PC root complex 350 and through a PCIe switch 360, to virtualize the input-output of the PCI root complex (FIG. 3). Patent Document 1 also discloses a computer system in which a plurality of host systems 1010, 1020 are connected to virtual planes 1040 and 1050, which are the end points of the host systems 1010 and 1020, through MRA switches (FIG. 10).

Patent Document 1: JP-A-2008-152783

### DISCLOSURE OF THE INVENTION

### Problem to be Solved by the Invention

The multi-root PCIe technology has been developed to share and effectively use IO resources to reduce costs. The technology has not been able to expand IO through a cable connection to a chassis having expansion IO supporting multi-root PCIe. In addition, the technology does not provide a configuration in which the expansion IO supporting multi-root PCIe is shared among a plurality of server chassis through cable connection. It is possible to expand IO by using the chassis for expansion IO, though specific technical means for sharing IO has not been developed yet.

Further, the data processing systems using the PCIe technology, which are described in Patent Document 1, involve individual blades in the same multi-root blade cluster system. There is no description of how the computer having the blades is connected to the IO chassis, nor any mention of the connection between a plurality of computers and one IO chassis, as well as the connection between one computer and a plurality of IO chassis and the like.

Accordingly, it is desirable to provide an information processing system using the PCIe technology to allow connection of a large number of IOs, and allow sharing of a large number of IOs among a plurality of servers. It is also desirable to achieve connection check of PCIe cables.

### MEANS FOR SOLVING THE PROBLEM

According to one preferred aspect of the present invention, there is provided an information processing system including: a server chassis including a plurality of server blades each having a processor, a memory, and a root complex, and a first multi-root PCIe switch connected to the server blades; and an IO chassis including a plurality of PCIe slots to which input-output devices are attached, and a second multi-root PCIe switch connected to the PCIe slots. The first multi-root PCIe switch and the second multi-root PCIe switch are connected by a PCIe cable.

In a preferred example, the first multi-root PCIe switch on one server chassis is connected to a plurality of second multi-root PCIe switches on each of the IO chassis.

In another preferred example, a plurality of first multi-root PCIe switches on each of the server chassis are connected to one second multi-root PCIe switch on the IO chassis.

In still another preferred example, a plurality of first multi-root PCIe switches on each of the server chassis are connected to a plurality of second multi-root PCIe switches on each of the IO chassis.

Further, preferably, the first multi-root PCIe switch includes: a plurality of upstream ports connected to the server blades; a plurality of downstream ports; a plurality of virtual switches; an upstream switch for switching connection between the plurality of upstream switches and the plurality of virtual switches; a downstream switch for switching connection between the plurality of virtual switches and the plurality of downstream ports; an upstream port-virtual switch assignment table for managing an assignment of the connection between the plurality of upstream switches and the plurality of virtual switches; a virtual switch-downstream port assignment table for managing an assignment of the connection between the plurality of virtual switches and the plurality of downstream ports; and a first management microcomputer for managing setting of the upstream port-virtual switch assignment table as well as the virtual switch-downstream port assignment table. In this way, the server blades on the server chassis are connected to the second multi-root PCIe switch of the IO chassis, by controlling switching of the upstream switch according to the upstream port-virtual switch assignment table, and by controlling switching of the downstream switch according to the virtual switch-downstream switch assignment table.

Furthermore, preferably the second multi-root PCIe switch includes: a plurality of upstream ports connected to the first multi-root PCIe switch; a plurality of downstream ports connected to the PCIe slots of the IO chassis; a plurality of virtual switches; an upstream switch for switching connection between the plurality of upstream switches and the plurality of virtual switches; a downstream switch for switching connection between the plurality of virtual switches and the plurality of downstream ports; an upstream port-virtual switch assignment table for managing an assignment of the connection between the plurality of upstream switches and the plurality of virtual switches; a virtual switch-downstream port assignment table for managing an assignment of the connection between the plurality of virtual switches and the plurality of downstream ports; and a second management microcomputer for managing setting of the upstream port-virtual switch assignment table as well as the virtual switch-downstream port assignment table. In this way, the first multi-root PCIe switch of the server blades on the server chassis is connected to the PCIe slots of the IO chassis, by controlling switching of the upstream switch according to the upstream port-virtual switch assignment table, and by controlling switching of the downstream switch according to the virtual switch-downstream port assignment table.

Still further, preferably the first and second management microcomputers are connected to a management console through a LAN cable. The first and second management microcomputers generate the upstream port-virtual switch assignment table and the virtual switch-downstream port assignment table, respectively, based on setting information input from the management console.

According to another preferred aspect of the present invention, there is provided a method of checking PCIe cable connection in an information processing system. The information processing system includes a first multi-root PCIe switch connected to a server blade in a server chassis, and a plurality of PCIe slots to which input-output devices are attached in the IO chassis. The first multi-root PCIe switch and the second multi-root PCIe switch are connected by a PCIe cable. The PCIe cable connection check method sequentially checks whether individual ports are correctly connected to their target ports by execution of management microcomputers of the first and second multi-root PCIe switches, based on a predetermined first assignment table that provides upstream port-virtual switch assignments, and on a predetermined second assignment table that provides virtual switch-downstream port assignments. Then, the method displays the check result in indicators on the particular ports.

Further, in a preferred example, the first and second management tables are generated by a management console connected to the server blade and the IO chassis. The first and second management tables are distributed from the management console to the server blade and the IO chassis, respectively.

### EFFECT OF THE INVENTION

According to the present invention, it is possible to achieve an information processing system using the PCIe technology to allow connection of a large number of IOs, and allow sharing of a large number of IOs among a plurality of servers, in response to a request of the system. In other words, one or a plurality of server blades can share one or a plurality of IO chassis through PCIe cable connection between a first MR-PCIe switch that aggregates a plurality of server blades in a server chassis and a second MR-PCIe switch that can connect a plurality of IOs.

### BEST MODE FOR CARRYING OUT THE INVENTION

Hereinafter, the embodiments of the present invention will be described in detail with reference to the accompanying drawings.

### First Embodiment

FIG. 1 is a block diagram of an information processing system with IO expansion.

One server chassis 10 is connected to three IO chassis 121 to 123 (collectively denoted by 12) respectively through a PCIe cable 15. The specific configuration of the server chassis 10 will be described later. The server chassis 10 mainly includes four server blades 201 to 204, and a multi root (MR)-PCIe switch 25. The server chassis 10 is connected to a plurality of IO chassis 12 by the MR-PCIe switch 25.

Each IO chassis 12 includes an MR-PCIe switch 13 and eight PCIe slots 141 to 148 (collectively denoted by 14). The MR-PCIe switch 13 on the IO chassis 12 is connected to the MR-PCIe switch 25 on the server chassis 10 by the PCIe cable 15.

Because of this connection configuration, the server blades 201 to 204 of the server chassis 10 can access up to 24 PCIe slots (8 PCIe slots×3 IO chassis).

Further, the MR-PCIe switches 25, 13 on the server chassis 10 and on the IO chassis 12 are connected to a management console 32 through a LAN switch 31, respectively. The management console 32 is, for example, formed by a personal computer, and has an input-output function and storage means such as a hard disc.

A user (system administrator) can operate the management console 32 to establish connection between the server chassis 10 and the IO chassis 12, and to monitor the attachment of the IO to the IO slot 14.

FIG. 2 shows the detailed configuration of the server chassis 10.

The server chassis 10 includes four server blades 201 to 204 (collectively denoted by 20), a back plane 24, and an MR-PCIe switch 25. The server blade 20 includes a memory 21, a processor (CPU) 22, and a root complex 23 having a plurality of PCIe ports for connecting the CPUs. The back plane 24 connects the root complex 23 of the server blade 20 and the MR-PCIe switch 25 together. Up to four server blades 20 can be mounted on the server chassis 10. However, the attachment of up to four server blades 20 is not necessarily required.

### Second Embodiment

FIG. 3 is a block diagram of an example of the information processing system in which a plurality of server chassis share one IO.

The information processing system is formed by connecting three server chassis 101 to 103 (collectively denoted by 10) to one IO chassis 121 through the PCIe cables 15. The configurations of the server chassis 10 and the IO chassis 13, the LAN switch 31, the management console 32, and the like, are the same as those shown in FIGS. 1 and 2.

Each of the server chassis 10 includes four server blades 20. Thus, up to twelve server blades 20 can share eight PCIe slots 14 (corresponding to eight IOs) in the IO chassis 121.

### Third Embodiment

FIG. 4 is a block diagram of an example of the information processing system in which a plurality of server chassis 101 to 103 share a plurality of IOs 121 to 123. It is to be noted that the configurations of the server chassis 10 and the IO chassis 13 are the same as those shown in FIGS. 1 and 2. The LAN switch 31 and the management console 32 are omitted from the figure.

According to this configuration, it is possible to connect one server blade 201 to up to twenty-four IOs by using the PCIe slots 14 of the individual IOs. Further, it is also possible to share one PCIe slot 14 among up to twelve server blades 20.

By connecting the MR-PCIe switch (the first MR-PCIe switch) on the server chassis 10 to the MR-PCIe switch (the second MR-PCIe switch) on the IO chassis 12 by the PCIe cable, it is possible to flexibly change the number of connected server chassis and the number of connected expansion IO chassis, in response to a request of the system (user). In addition, because of the two-stage structure of the first and second MR-PCIe switches, flexible connection between server blades and PCIe slots can be achieved.

FIG. 5 shows the detailed configuration of the MR-PCIe switch.

The multi-root PCIe switches 25, 13 on the server chassis 10 and on the IO chassis 12 have the same configuration, although the destinations of the ports of the respective multi-root PCIe switches 25, 13 are different.

The MR-PCIe switch includes a management microcomputer (micro CPU) 51 for managing the setting of the switches, and a switch LSI 52.

The switch LSI 52 has four upstream ports and eight downstream ports, realizing the MR-PCIe switch function. The switch LSI 52 includes sixteen virtual switches 57, an upstream connection switch 55 for connecting between the upstream ports and the virtual switches 57, a downstream switch 56 for connecting between the virtual switches 57 and the downstream ports, an upstream port virtual switch assignment table 53 for managing the assignment of the upstream ports to the virtual switches 57, and a virtual switch-downstream switch assignment table 54 for managing the assignment of the virtual switches 57 to the downstream ports.

The management microcomputer 51 is also connected to the LAN switch 31. The contents of the management tables 53, 54 are set or changed under the control of the management microcomputer 51 by an instruction from the management console 32 in response to a request of the system (user).

### [Switch Assignment Management in the First Embodiment]

Next, the switch assignment using the switch assignment management tables 53, 54 in the information processing system of the first embodiment (FIG. 1) will be described with reference to FIGS. 6 to 9.

Here, the MR-PCIe switch 25 on the server chassis 101 can be connected to four saver blades by using four upstream ports. Also, the MR-PCIe switch 25 on the server chassis 101 can be connected to four IO chassis by using four downstream ports. In the following description, it is assumed that one server blade 201 is connected to the upstream port of the MR-PCIe switch 25, and that three MR-PCIe switches 13 mounted on each of the IO chassis 12 are connected by using three downstream ports.

FIG. 6 is a view of the upstream port-virtual switch assignment table 53 of the MR-PCIe switch on the server chassis 101. It is shown that the server blade 201 connected to one upstream port 1 uses one virtual switch 1.

FIG. 7 is a view of the virtual switch-downstream port assignment table 54 of the MR-PCIe switch 25 on the server chassis 101. It is shown that virtual downstream ports 1 to 4 of the virtual switch 1 are connected to physical downstream ports 1 to 4, respectively.

Because of the port assignment shown in FIGS. 6 and 7, for example, the server blade 201 can occupy the downstream ports 1 to 4 of the MR-PCIe switch 25 on the server chassis 10.

FIG. 8 is a view of the upstream port-virtual switch assignment table 53 of the MR-PCIe switch 13 mounted on each of the IO chassis 121 to 123. The upstream port 1 of the IO chassis 121 is connected to the downstream port 1 of the server chassis 10. Thus, the server blade 201 uses the virtual switch 1 on the IO chassis 121. Also, the server blade 201 uses the virtual switch 1 mounted on the IO chassis 122 and on the IO chassis 123 as well.

FIG. 9 is a view of the virtual switch-downstream port assignment table 54 of the MR-PCIe switch 13 mounted on each of the IO chassis 121 to 123. The downstream ports 1 to 8 of the PCIe switch 13 on the IO chassis are connected to the PCIe slots 141 to 148. The virtual downstream ports 1 to 8 of the virtual switch on the IO chassis 121 are connected to the physical downstream ports 1 to 8.

The assignment tables shown in FIGS. 6 to 8 are generated by the process means (CPU and software executed therein) in the management console 32, and are transferred to the management microcomputers 51 of the MR-PCIe switches.

Because of the assignment described above, it is possible to use all the PCIe slots provided in the three IO chassis 121 to 123. That is, a total of 25 IOs can be used simultaneously.

### [Switch Assignment Management in the Second Embodiment]

Next, the switch assignment management using the switch assignment management tables 53, 54 in the information processing system of the second embodiment (FIG. 3) will be described with reference to FIGS. 10 to 13.

FIG. 10 is a view of the upstream port-virtual switch assignment table 53 of the MR-PCIe switch 25 mounted on each of the server chassis 101 to 103. The server blade 201 connected to the upstream port 1 uses the virtual switch 1. Similarly, the server blades 202, 203, and 204 connected to the upstream ports 2, 3, and 4, respectively, use the virtual switches 2, 3, and 4.

FIG. 11 is a view of the virtual switch-downstream port assignment table 54 of the MR-PCIe switch 25 mounted on each of the server chassis 101 and 102. The virtual downstream port 1 of the virtual switches 1 to 4 is connected to each of the virtual ports 1 to 4 of the physical downstream port 1.

Because of the port assignment shown in FIGS. 10 and 11, the server blades 201 to 204 can share the downstream port 1 of the MR-PCIe switch 53 mounted on each of the server chassis 101 to 103. Thus, the server blades 201 to 204 can use the virtual ports 1 to 4.

FIG. 12 is a view of the upstream port-virtual switch assignment table 53 of the MR-PCIe switch 13 on the IO chassis 121. The upstream port 1 of the IO chassis 121 is connected to the downstream port 1 of the server chassis 101. Further, the downstream port 1 of the server chassis 101 is shared among the server blades 201 to 204. Thus, the virtual switches 1 to 4 on the IO chassis 121 are used by the server blades 201 to 204 on the server chassis 101. Similarly, the virtual switches 5 to 8 are used by the server blades 201 to 204 on the sever chassis 102, and the virtual switches 9 to 12 are used by the server blades 201 to 204 on the server chassis 103.

FIG. 13 is a view of the virtual switch-downstream port assignment table of the MR-PCIe switch 13 on the IO chassis 121. The downstream ports 1 to 8 of the PCIe switch on the IO chassis 121 are connected to the PCIe slots 141 to 148. The virtual downstream ports 1 to 8 provided in each of the virtual switches 1 to 12 on the IO chassis 121 are connected to the physical downstream ports 1 to 8, respectively.

The assignment tables shown in FIGS. 9 to 13 are generated by the process means (CPU and software executed therein) of the management console 32. Then, the generated assignment tables are transferred to the management microcomputers 51 of the MR-PCIe switches.

Because of the setting described above, the server blades 201 to 204 provided in each of the server chassis 101 to 103 can share the PCIe slots 141 to 148 in the IO chassis 121, respectively.

### [The Switch Assignment Management in the Third Embodiment]

Next, the switch assignment using the switch assignment management tables 53, 54 in the information processing system of the third embodiment 3 (FIG. 4) will be described with reference to FIGS. 14 to 17.

In this example, the downstream ports 1, 2, and 3 in the server chassis 101 are connected to the upstream port 1 in each of the IO chassis 121, 122, and 123, respectively. Similarly, the downstream ports 1, 2, and 3 in the server chassis 102 are connected to the upstream port 2 in each of the IO chassis 121, 122, and 123, respectively. Then, the downstream ports 1, 2, and 3 in the server chassis 103 are connected to the upstream port 3 in each of the IO chassis 121, 122, and 123, respectively.

FIG. 14 is a view of the upstream port-virtual switch assignment table 53 of the MR-PCIe switch 25 mounted on each of the sever chassis 101 to 103. The server blade 201 connected to the upstream port 1 uses the virtual switch 1. Similarly, the server blades 202, 203, and 204 connected to the upstream ports 2, 3, and 4, respectively, use the virtual switches 2, 3, and 4.

FIG. 15 is a view of the virtual switch-downstream port assignment table 54 of the MR-PCIe switch 25 mounted on each of the server chassis 101 to 103. The virtual switch 1 of the virtual switches 1 to 4 is connected to the virtual ports 1 to 4 of the physical downstream port 1. Similarly, the virtual downstream ports 2, 3, and 4 of the virtual switches 1 to 4 are connected to the virtual ports 1 to 4 of the physical downstream ports 2, 3, and 4, respectively.

Because of the setting shown in FIGS. 14 and 15, the server blades 201 to 204 can share the downstream ports 1 to 3 of the MR-PCIe switch 25 on each of the server chassis 101 to 103. In this way, the server blades 201 to 204 can use the virtual ports 1 to 4.

FIG. 16 is a view of the upstream port-virtual switch assignment table 53 of the MR-PCIe switch 13 on each of the IO chassis 121 to 123. The upstream port 1 of the IO chassis 121 to 123 is connected to the downstream port 1 of the server chassis 101. Further, the downstream port 1 of the server chassis 101 is shared among the server blades 201 to 204. Thus, the server blades 201 to 204 of the server chassis 101 can use the virtual switches 1 to 4 of the IO chassis 121. Similarly, the server blades 201 to 204 of the server chassis 102 can use the virtual switches 5 to 8. Further, the server blades 201 to 204 of the server chassis 103 can use the virtual switches 9 to 12.

FIG. 17 is a view of the virtual switch-downstream port assignment table 54 of the MR-PCIe switch 13 on the IO chassis 121. The downstream ports 1 to 8 of the PCIe switch on the IO chassis are connected to the PCIe slots 141 to 148. The virtual downstream ports 1 to 8 provided in each of the virtual switches 1 to 12 on the IO chassis 121 are connected to the physical downstream ports 1 to 8, respectively.

The assignment tables shown in FIGS. 14 to 17 are generated by the process means (CPU and software executed therein) in the management console 32. Then, the generated assignment tables are transferred to the management microcomputers 51 of the MR-PCIe switches.

As described above, the server blades 201 to 204 in each of the server chassis 101 to 103 are set so as to share the PCIe slots in each of the IO chassis 121 to 123, respectively.

### [Sharing of PCIe Cables and PCIe Wiring]

Next, the sharing of PCIe cables and PCIe wiring will be described with reference to the second embodiment.

The MR-PCIe switch adds a virtual port number 1802 as a tag to a PCIe packet 1801. The virtual port number is added based on the virtual switch-downstream port assignment table 54.

For example, as shown in FIG. 19, a PCIe packet A issued from the server blade 201 on the server chassis 101 enters the upstream port 1 of the MR-PCIe switch 25. The PCIe packet A enters the virtual switch 1 according to the upstream port-virtual switch assignment table 53. Then, the PCIe packet A is transmitted to the virtual port 1 of the downstream port 1 according to the virtual switch-downstream port assignment table 54. At this time, the PCIe packet A is issued with virtual port “1” attached to the tag, and is transmitted to the PCIe cable between the server chassis 101 and the IO chassis 121.

Further, the PCIe packet enters the MR-PCIe switch 13 on the IO chassis 121, and then enters the virtual switch 1 according to the upstream port-virtual switch assignment table 53. In the virtual switch 1, the PCIe packet is rooted by the address or RID according to the PCIe specification, and is transmitted, for example, to the virtual port 1. Then, the PCIe packet is transmitted to the virtual port 1 of the downstream port 1 according to the virtual switch-downstream port assignment table 54.

Similarly, a PCIe packet B is issued from the server blade 201 on the server chassis 101. At this time, the PCIe packet B is issued with virtual port “2” attached to the tag, and is transmitted to the PCIe cable 15 between the server chassis 101 and the IO chassis 121. Then, the PCIe packet is issued with a tag of virtual port “2”, and is transmitted from the MR-PCIe switch 13 to the PCIe slot 141.

A PCIe packet C is issued from the server blade 201 on the server chassis 102. At this time, the PCIe packet C is issued with virtual port “1” attached to the tag, and transmitted to the PCIe cable 15 between the server chassis 102 and the IO chassis 121. Then, the PCIe packet C is issued with a tag of virtual port “5”, and transmitted from the MR-PCIe switch 13 to the PCIe slot 141.

A PCIe packet D is issued from the server blade 202 on the server chassis 102. At this time, the PCIe packet D is issued with virtual port “1” attached to the tag, and is transmitted to the PCIe cable 15 between the server chassis 102 and the IO chassis 121. Then, the PCIe packet is issued with a tag of virtual port “6”, and is transmitted from the MR-PCIe switch 13 of the IO chassis 121 to the PCIe slot 141.

Next, the way of establishing the information processing system will be described with reference to FIGS. 22 to 24. For example, in the second embodiment (FIG. 3), the user operates the management console 32 to input the system configuration that the user desires to establish, into the switch management microcomputer. For this purpose, the user inputs the ID and IP address assignment to each server chassis as well as the ID and IP address assignment to each IO chassis, from the management console 32. These assignments are registered in the storage means of the management console 32 as shown in FIG. 20.

The management console 32 checks the LAN connection to determine whether it is possible to communicate with the respective management microcomputers 51 of the server chassis and the IO chassis, based on the IP addresses having been registered in the storage means (FIG. 23).

Next, the user inputs the information on the server chassis and expansion IO chassis belonging to each system (server group), from the management console 32. Then, the user registers the information in the storage means (FIG. 21). Here, the server group is a group of server chassis and expansion IO chassis to be connected to each other by MR-PCIe cables. Examples of the server group are as shown in FIG. 1, 3, or 4.

Further, the user registers the information indicating that the individual PCIe slots on the IO chassis are shared among which server blades of which server chassis, into the storage means from the management console 32 (FIG. 22).

The management console 32 generates the upstream port-virtual switch assignment table 53 and the virtual switch-upstream port assignment table 54, based on the registration information. Then, the management console 32 distributes the generated assignment tables to the management microcomputer 51 of the MR-PCIe switch 25 on the server chassis and to the management microcomputer 51 of the MR-PCIe switch 13 on the IO chassis, respectively. Each switch management microcomputer 51 determines the server chassis ID, IO chassis ID, and port number that the destination switch belongs to, based on the assignment table.

Then, the management microcomputer 51 on the server chassis communicates with the management microcomputer 51 on the IO chassis to show the PCIe cable connection state to the user by displaying an indicator (for example, an LED) provided in each port.

In other words, the management microcomputer 51 on the server chassis refers to the port assignment table of the server group (FIG. 22) that is distributed from the management console. Then, the management microcomputer 51 shows the connection between the downstream port “1” of the server chassis 101 and the upstream port “1” of the IO chassis 121. The management microcomputer 51 checks the link connection between the two ports to determine whether the two ports are connected correctly. This check is done based on whether the unique ID that has been set for each port can be recognized by the management microcomputer 51.

As a result of the connection check, if the two ports are connected correctly, the management microcomputer 51 turns off the green LED mounted on the particular ports, and proceeds to the next cable check. In other words, the management microcomputer 51 shows the connection between the downstream port “1” of the server chassis 101 and the upstream port “2” of the IO chassis 121.

On the other hand, if the two ports are not linked as a result of the connection check, the management microcomputer 51 turns on the green LED on the two ports. Further, if two ports are connected incorrectly, the management microcomputer 51 turns on the red LED on the two ports that are connected incorrectly. When a link down due to cable disconnection is detected, the management microcomputer 51 turns on the green LED on the two ports that have to be connected originally. Then, when the correct connection is detected, the management microcomputer 51 turns off the green LED, and proceeds to check the next cable. More specifically, the management microcomputer 51 shows the connection between the downstream port “1” of the server chassis 101 and the upstream port “2” of the IO chassis 121.

In this way, the management microcomputer 51 checks the connection with respect to all the upstream ports and downstream ports that are registered in the assignment table of FIG. 22, while sequentially updating downstream port numbers 1 to i of the server chassis 101 and upstream port numbers 1 to j of the IO chassis 121.

Next, similarly to the above, the management microcomputer 51 of the server chassis 101 shows the connection between the downstream port 2 of the server chassis 101 and the upstream port 1 of the IO chassis 122. In this case also, the management microcomputer 51 shows the connection between all the ports to the user by the LED lights.

### BRIEF DESCRIPTION OF THE DRAWINGS

FIG. 1 is a block diagram of the information processing system according to a first embodiment;

FIG. 2 is a block diagram of the server chassis 10 in the information processing system of the first embodiment;

FIG. 3 is a block diagram of the information processing system according to a second embodiment;

FIG. 4 is a block diagram of the information processing system according to a third embodiment;

FIG. 5 is a block diagram of the MR-PCIe switch;

FIG. 6 is a view of the upstream port-virtual switch assignment table 53 provided in the MR-PCIe switch 25 on the server chassis 10 according to the first embodiment;

FIG. 7 is a view of the virtual switch-downstream port assignment table 54 provided in the MR-PCIe switch 25 on the server chassis 10 according to the first embodiment;

FIG. 8 is a view of the upstream port-virtual switch assignment table 53 provided in the MR-PCIe switch 13 on the IO chassis 12 according to the first embodiment;

FIG. 9 is a view of the virtual switch-downstream port assignment table 54 provided in the MR-PCIe switch 13 on the IO chassis 12 according to the first embodiment;

FIG. 10 is a view of the upstream port-virtual switch assignment table 53 provided in the MR-PCIe switch 25 on the server chassis 10 according to the second embodiment;

FIG. 11 is a view of the virtual switch-downstream port assignment table 54 provided in the MR-PCIe switch 25 on the server chassis 10 according to the second embodiment;

FIG. 12 is a view of the upstream port-virtual switch assignment table 53 provided in the MR-PCIe switch 13 on the IO chassis 12 according to the second embodiment:

FIG. 13 is a view of the virtual switch-downstream port assignment table 54 provided in the MR-PCIe switch 13 on the IO chassis 12 according to the second embodiment;

FIG. 14 is a view of the upstream port-virtual switch assignment table 53 provided in the MR-PCIe switch 25 on the server chassis 10 according to the third embodiment;

FIG. 15 is a view of the virtual switch-downstream port assignment table 54 provided in the MR-PCIe switch 25 on the server chassis 10 according to the third embodiment;

FIG. 16 is a view of the upstream port-virtual switch assignment table 53 provided in the MR-PCIe switch 13 on the IO chassis 12 according to the third embodiment;

FIG. 17 is a view of the virtual switch-downstream port assignment table 54 provided in the MR-PCIe switch 13 on the IO chassis 12 according to the third embodiment;

FIG. 18 is a view showing the structure of a multi-root transaction packet;

FIG. 19 is a view of an example of the routing of the multi-root transaction packet;

FIG. 20 shows server chassis ID-IP address and 10 chassis-IP address assignment tables;

FIG. 21 shows assignment tables of server chassis IDs and IO chassis IDs belonging to server groups;

FIG. 22 shows a PCIe slot sharing map;

FIG. 23 shows an operation example of the connection check between the server chassis and the IO chassis; and

FIG. 24 shows an example of the IO expansion in a conventional computer system.

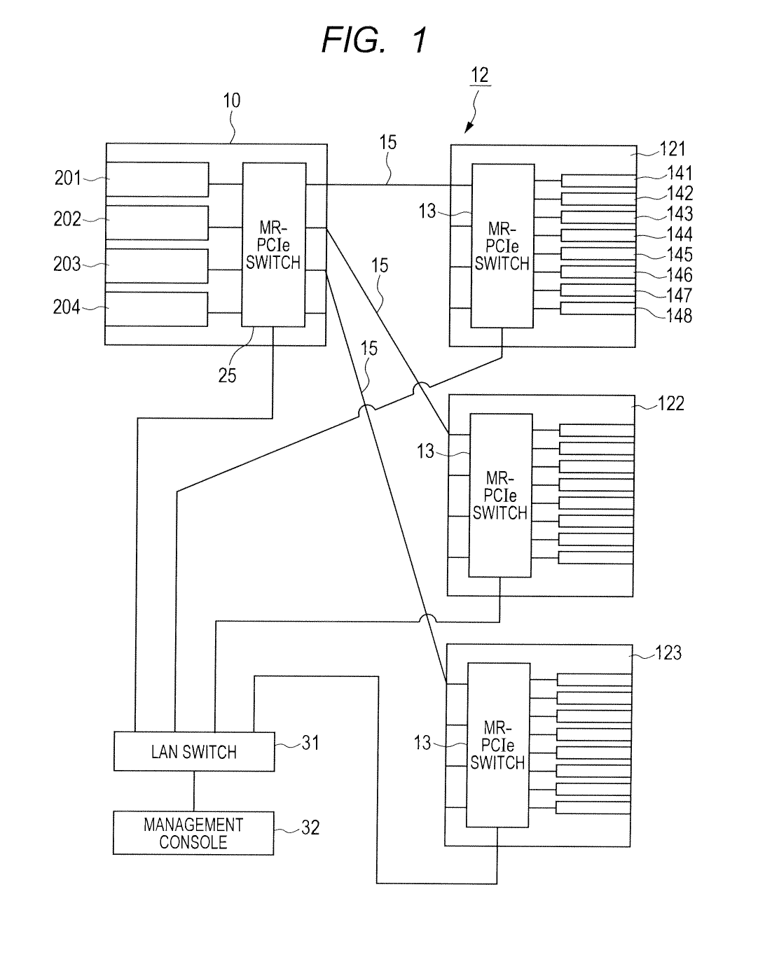

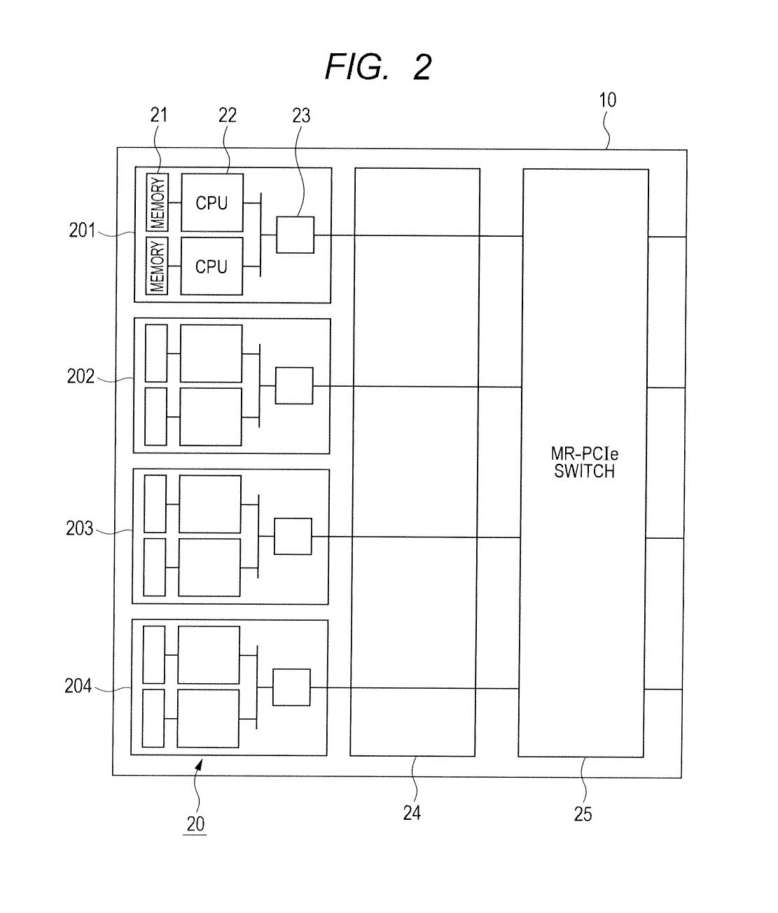

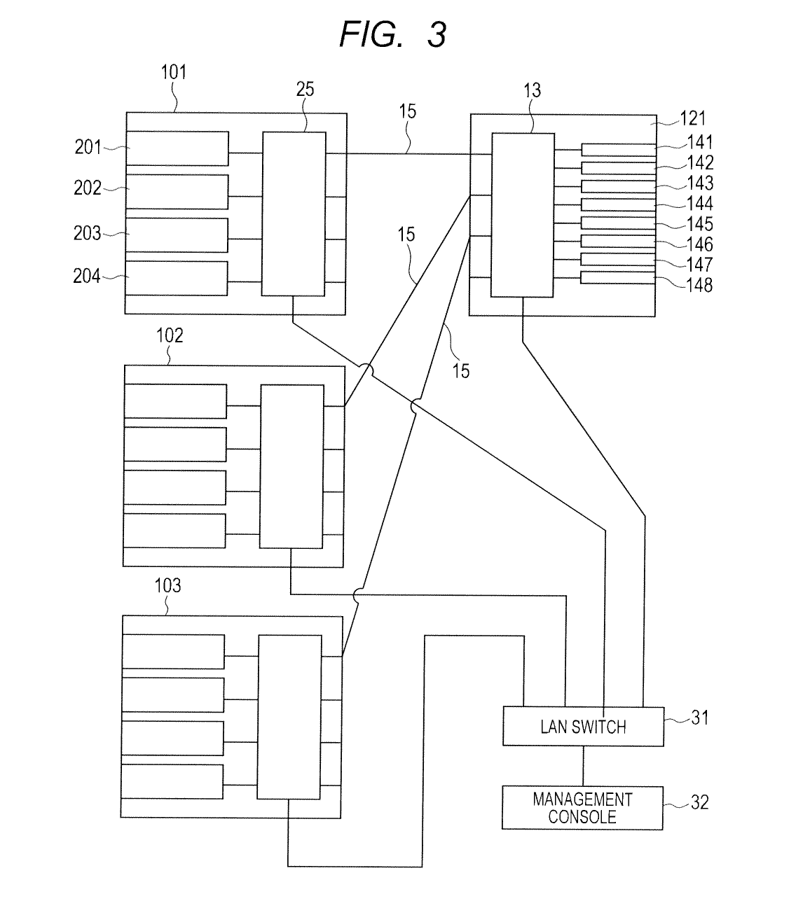

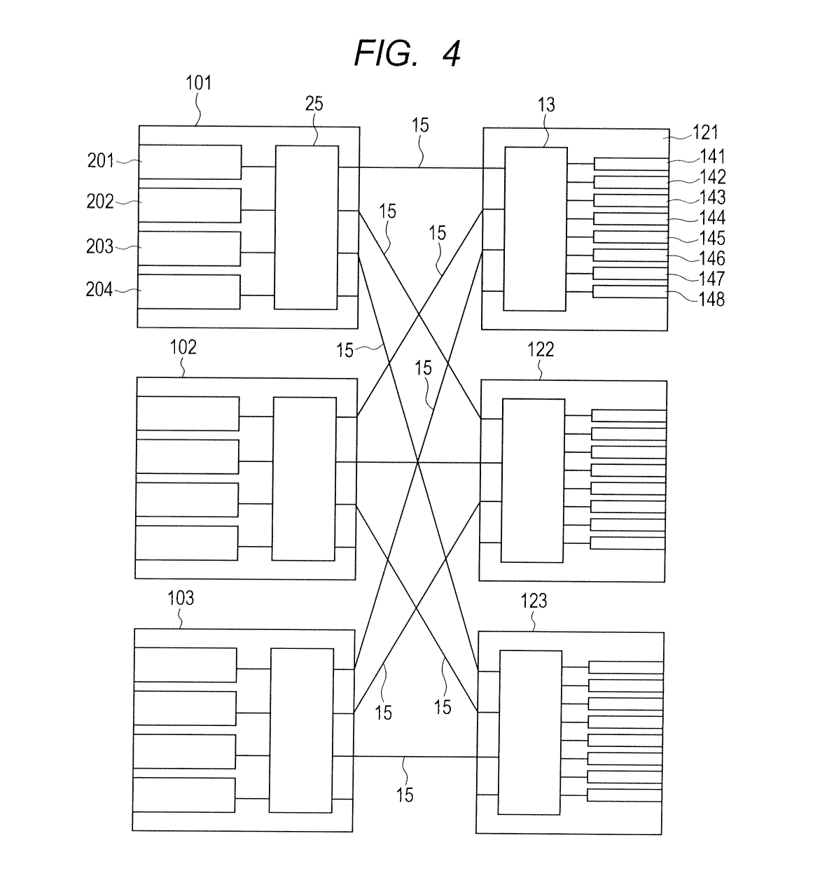

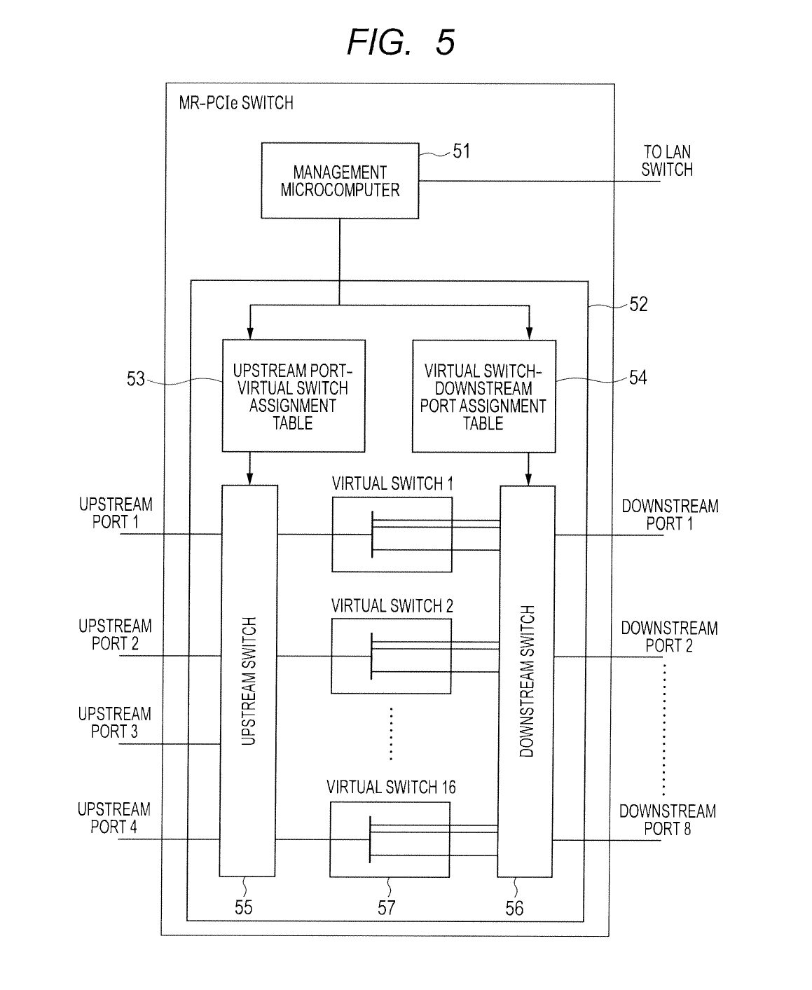

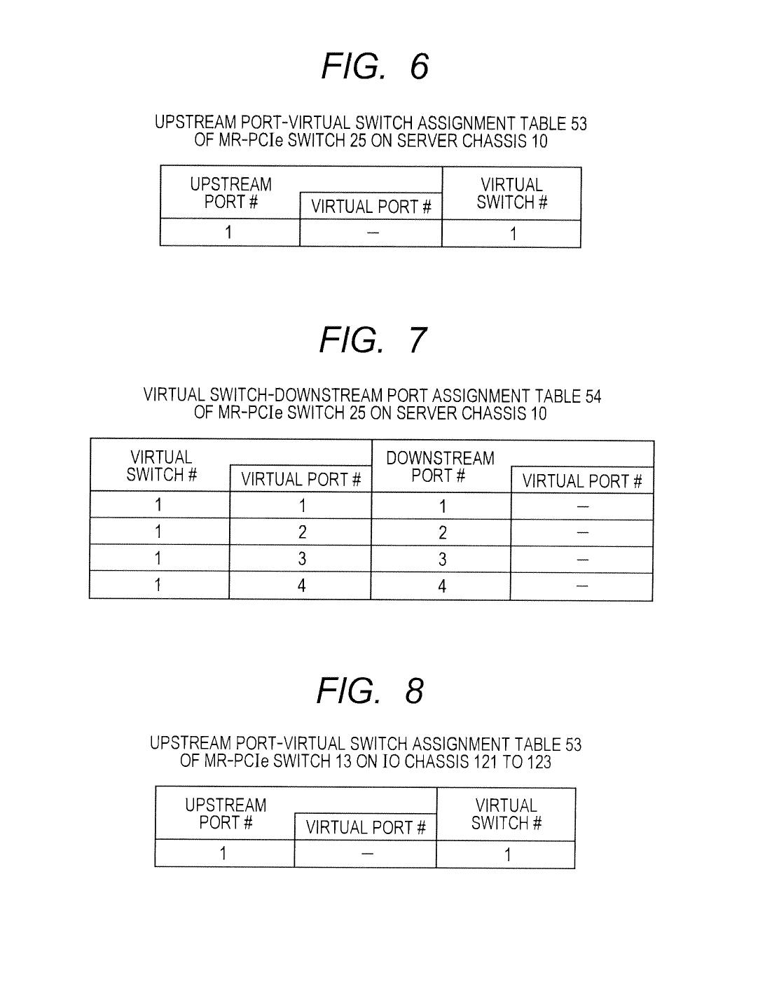

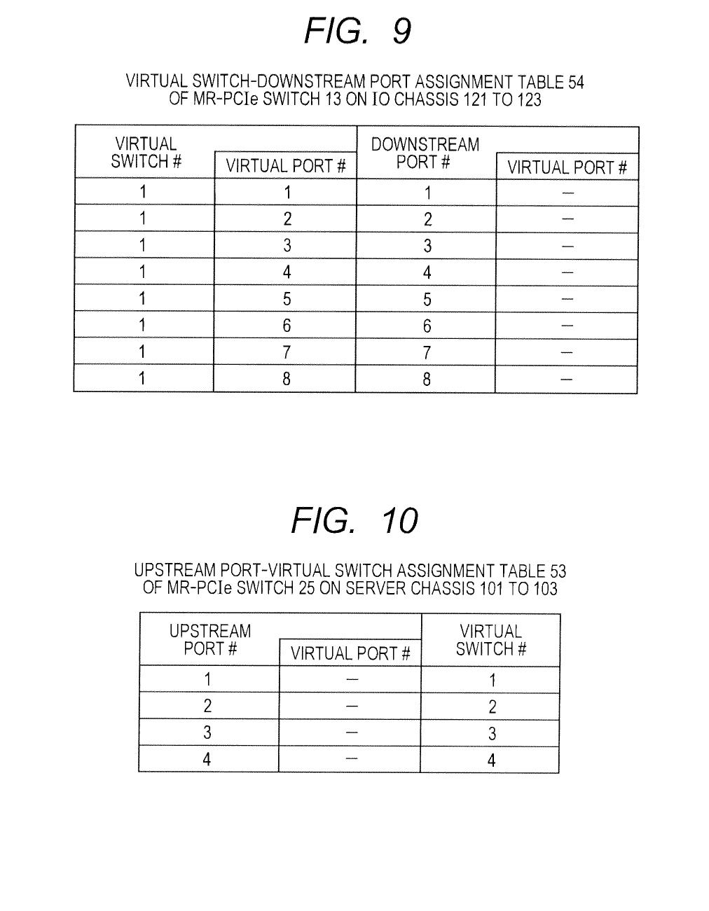

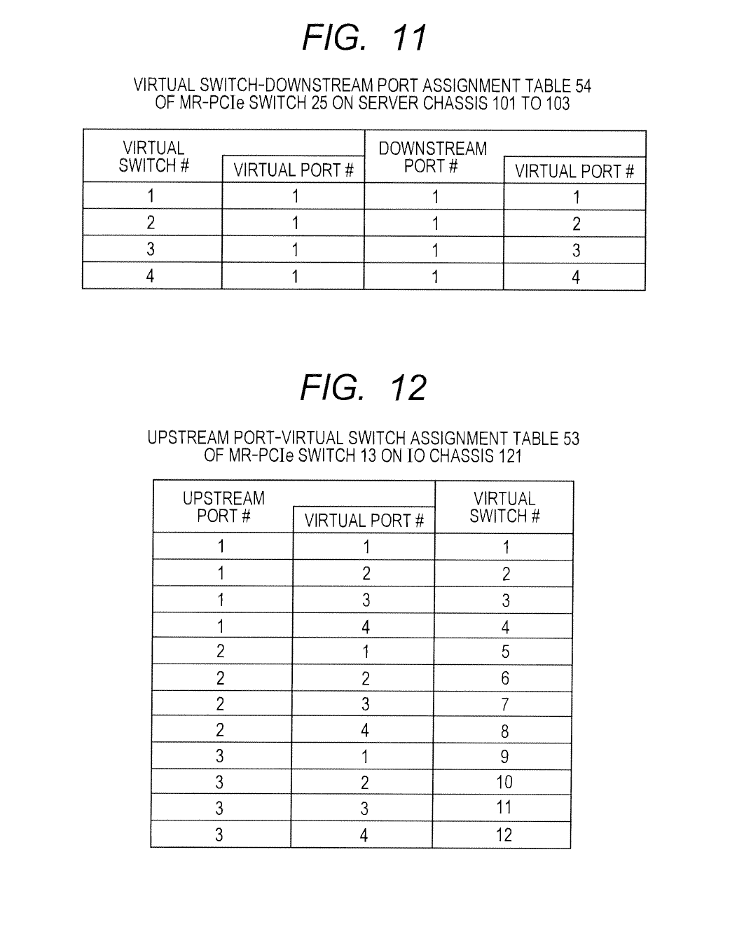

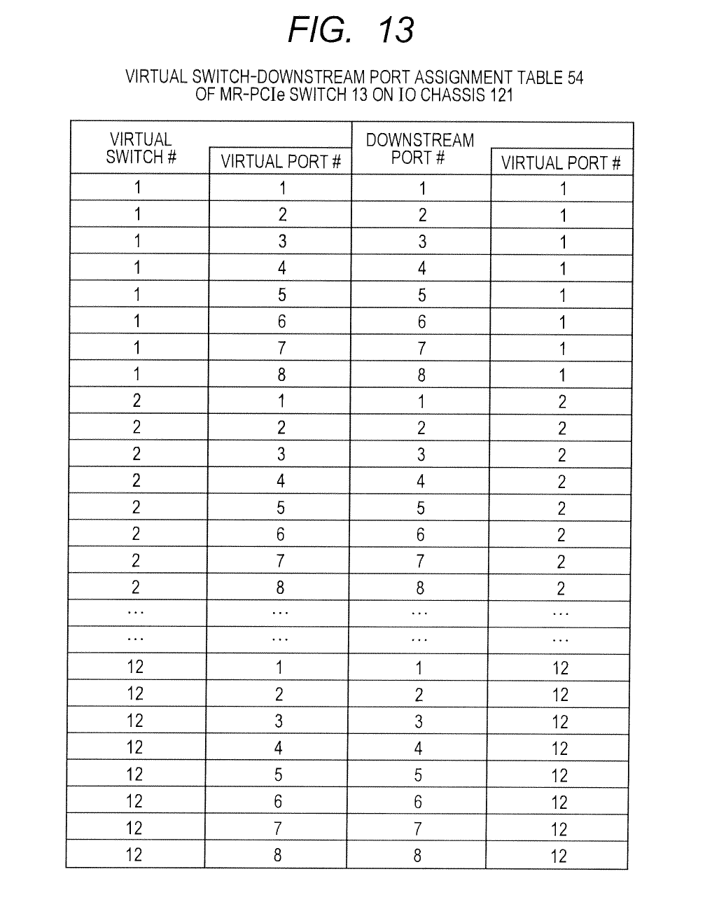

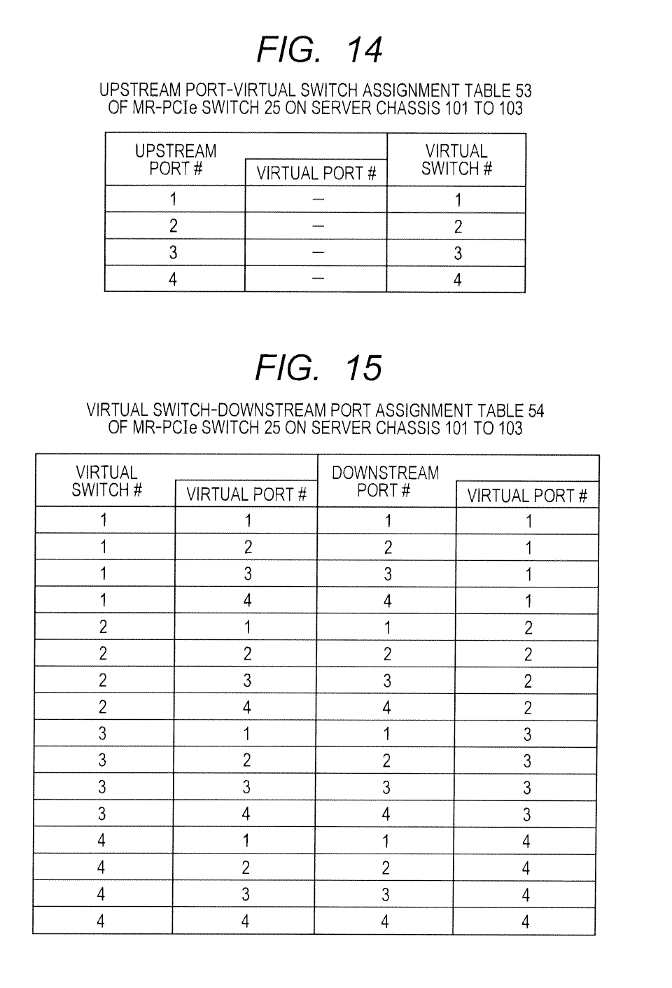

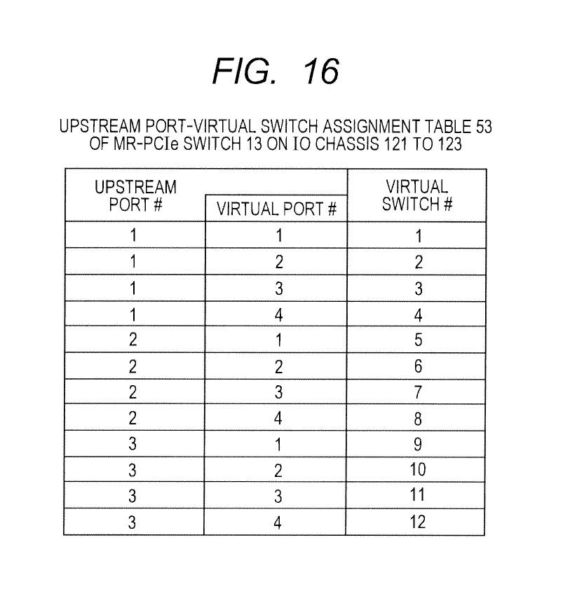

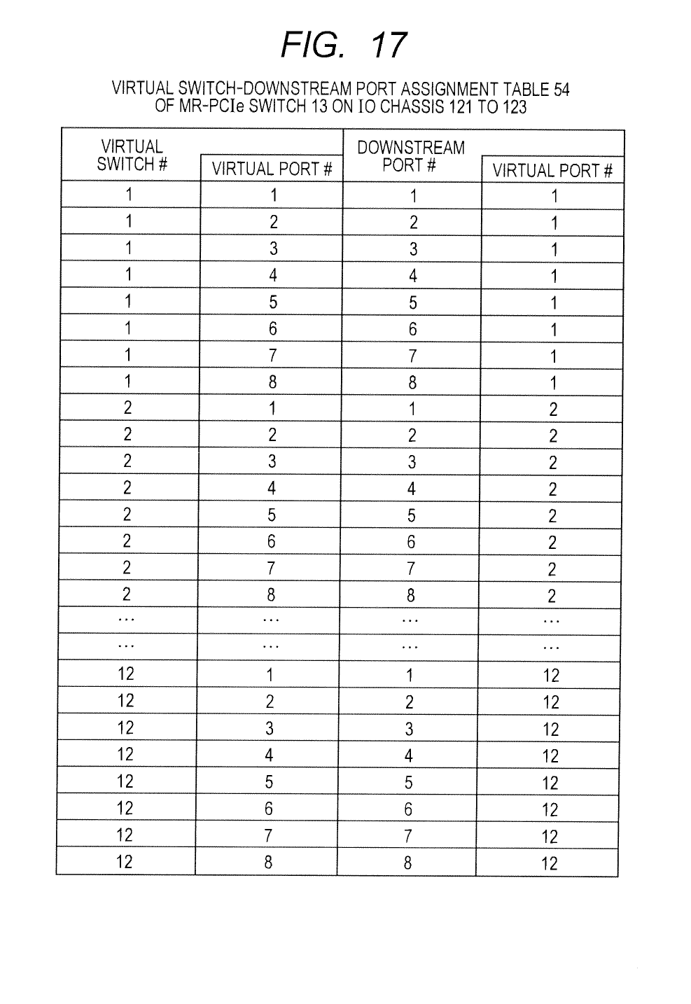

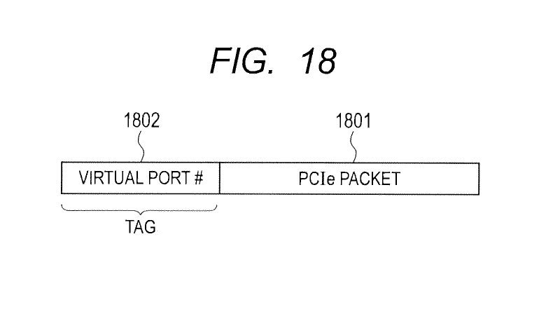

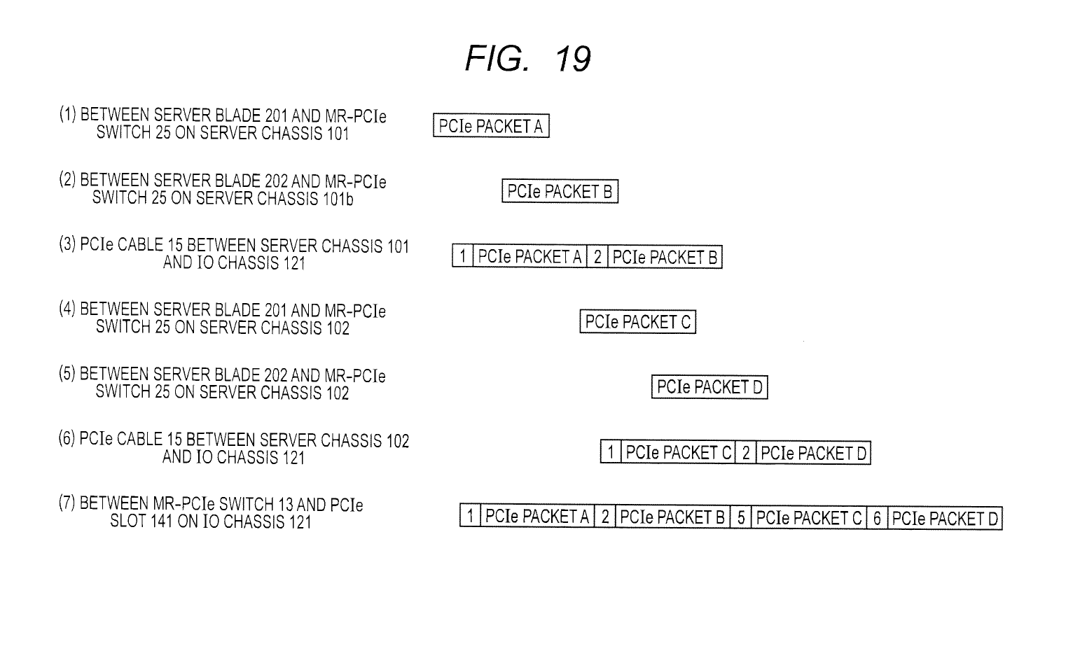

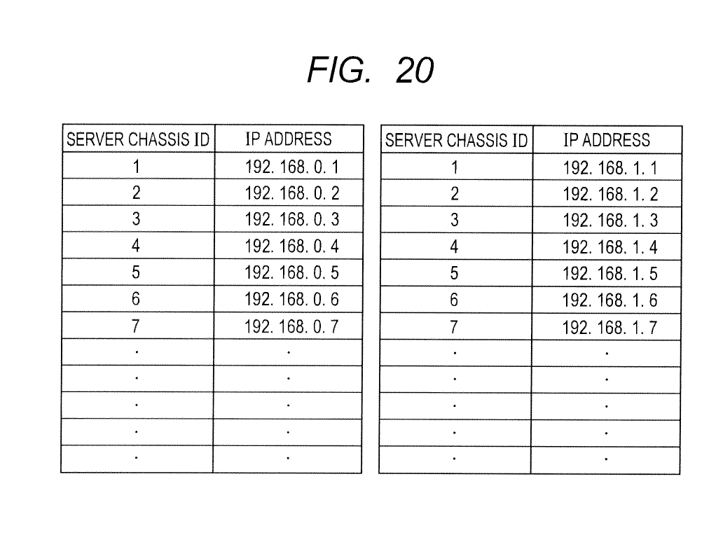

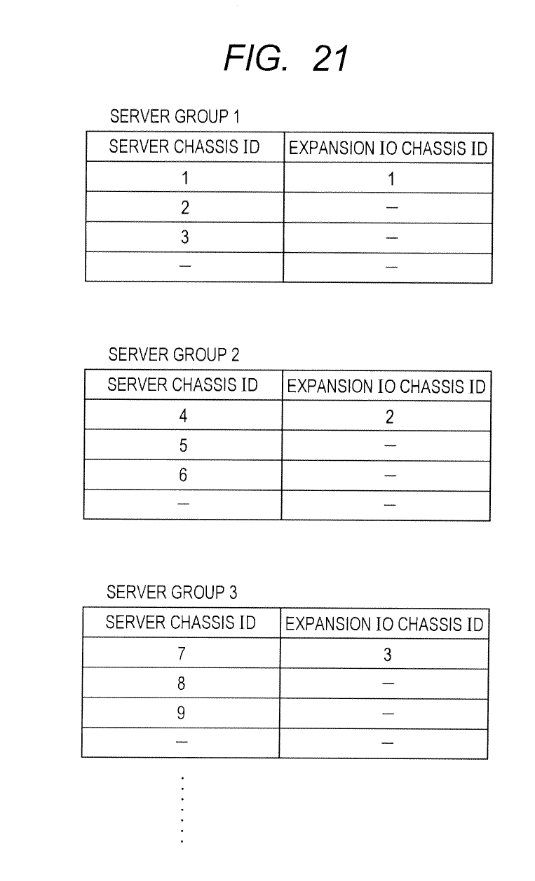

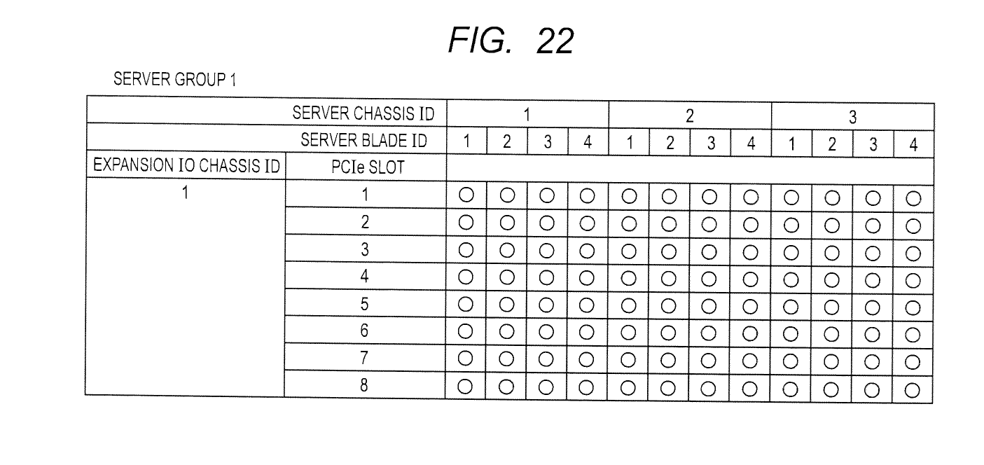

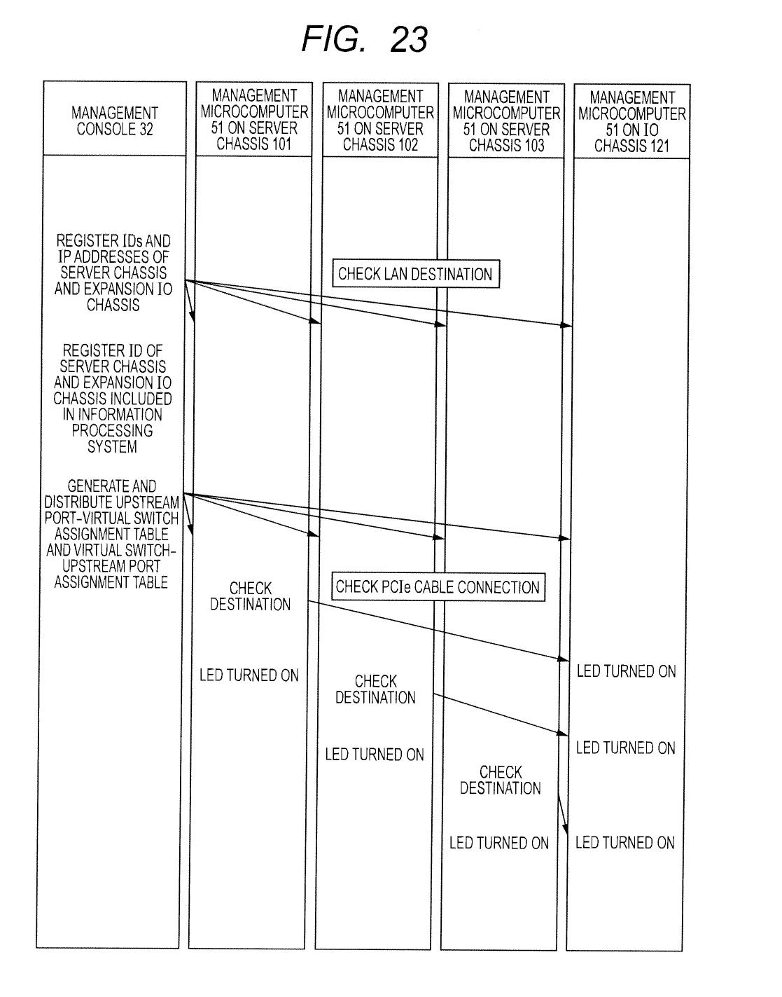

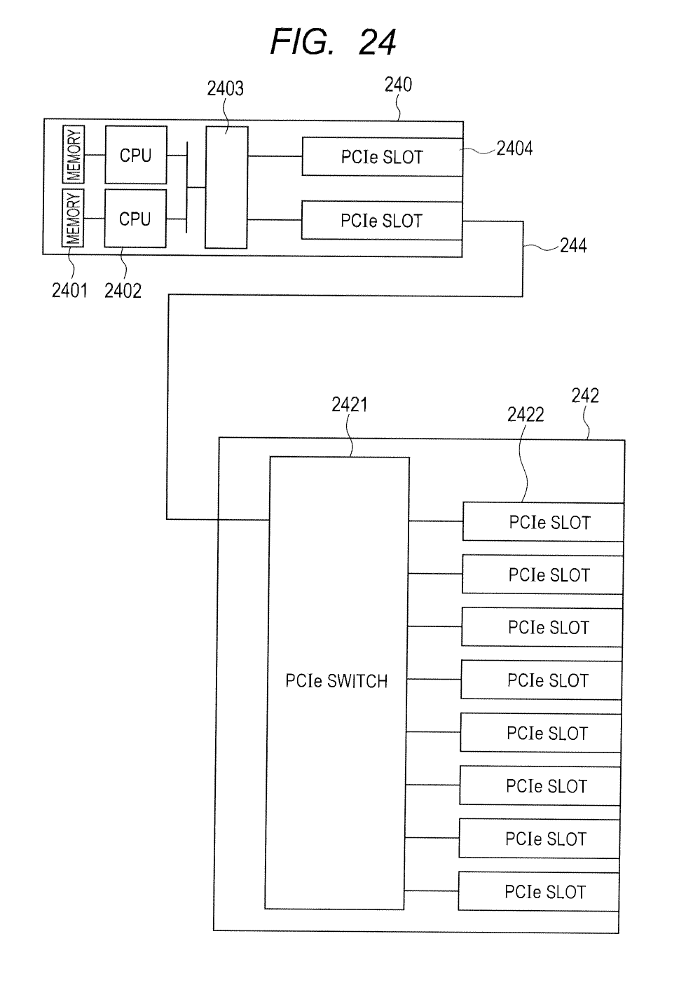

### DESCRIPTION OF REFERENCE NUMERALS

10, 101 to 103: server chassis

12, 121 to 123: IO chassis

201 to 204: server blade

21: memory

22: CPU

23: root complex

24: back plane

25, 13: MR-PCIe switch

14, 141 to 148: PCIe slot

15: PCIe cable

51: management microcomputer

52: MR-PCIe switch LSI

53: upstream port-virtual switch assignment table

54: virtual switch-downstream port assignment table

55: upstream port-virtual switch connection switch

56: virtual switch-downstream port connection switch

57: virtual switch

1. An information processing system comprising:
a server chassis including a plurality of server blades each having a processor, a memory, and a root complex, and a first multi-root PCIe switch connected to the server blades; and
an IO chassis including a plurality of PCIe slots to which input-output devices are attached, and a second multi-root PCIe switch connected to the PCIe slots, wherein the first multi-root PCIe switch and the second multi-root PCIe switch are connected by a PCIe cable.

2. The information processing system according to claim 1, wherein the first multi-root PCIe switch on one server chassis is connected to a plurality of second multi-root PCIe switches on each of the IO chassis.

3. The information processing system according to claim 1, wherein a plurality of first multi-root PCIe switches on each of the server chassis are connected to the second multi-root PCIe switch on one IC chassis.

4. The information processing system according to claim 1, wherein a plurality of first multi-root PCIe switches on each of the server chassis are connected to a plurality of second multi-root PCIe switches on each of the IO chassis.

5. The information processing system according to claim 1,
wherein the first multi-root PCIe switch includes:
a plurality of upstream ports to which the server blades are connected;
a plurality of downstream ports;
a plurality of virtual switches;
an upstream switch for switching connection between the plurality of upstream ports and the plurality of virtual switches;
a downstream switch for switching connection between the plurality of virtual switches and the plurality of downstream ports;
an upstream port-virtual switch assignment table for managing an assignment of the connection between the plurality of upstream ports and the plurality of virtual switches;
a virtual switch-downstream port assignment table for managing an assignment of the connection between the plurality of virtual switches and the plurality of downstream ports; and
a first management microcomputer for managing setting of the upstream port-virtual switch assignment table as well as the virtual switch-downstream port assignment table, and
wherein the information processing system connects the server blade of the server chassis to the second multi-root PCIe switch of the IO chassis, by controlling switching of the upstream switch according to the upstream port-virtual switch assignment table, and by controlling switching of the downstream switch according to the virtual switch-downstream port assignment table.

6. The information processing system according to claim 1,
wherein the second multi-root PCIe switch includes:
a plurality of upstream ports connected to the first multi-root PCIe switch;
a plurality of downstream ports connected to the PCIe slots of the IO chassis;
a plurality of virtual switches;
an upstream switch for switching connection between the plurality of upstream ports and the plurality of virtual switches;
a downstream switch for switching connection between the plurality of virtual switches and the plurality of downstream ports;
an upstream port-virtual switch assignment table for managing an assignment of the connection between the plurality of upstream ports and the plurality of virtual switches;
a virtual switch-downstream port assignment table for managing an assignment of the connection between the plurality of virtual switches and the plurality of downstream ports; and
a second management microcomputer for managing setting of the upstream port-virtual switch assignment table as well as the virtual switch-downstream port assignment table, and
wherein the information processing system connects the first multi-root PCIe switch of the server blades on the server chassis to the PCIe slots of the IO chassis, by controlling switching of the upstream switch according to the upstream port-virtual switch assignment table, and by controlling switching of the downstream switch according to the virtual switch-downstream port assignment table.

7. The information processing system according to claim 5,
wherein the first and second management microcomputers are connected to a management console through a LAN cable, and
wherein the first and second management microcomputers generate the upstream port-virtual switch assignment table and the virtual switch-downstream port assignment table, respectively, based on setting information input from the management console.

8. A PCIe cable connection check method in an information processing system including a first multi-root PCIe switch connected to a server blade in a server chassis, and a second multi-root PCIe switch connected to a plurality of PCIe slots to which input-output devices are attached in an IO chassis, the first multi-root PCIe switch and the second multi-root PCIe switch being connected by a PCIe cable, the PCIe cable connection check method comprising the steps of:
sequentially checking whether individual ports are correctly connected to their target ports by execution of management microcomputers of the first and second multi-root PCIe switches, based on a predetermined first assignment table that provides upstream port-virtual switch assignments, and on a predetermined second assignment table that provides virtual switch-downstream port assignments; and
displaying the check result in indicators on the particular ports.

9. The PCIe cable connection check method according to claim 8,
wherein the first and second management tables are generated by a management console connected to the server blade and the IO chassis, and
wherein the first and second management tables are distributed from the management console to the server blade and the IO chassis, respectively.
